(19) United States
(12) Patent Application Publication
(10) Pub. No.: US 2024/0010503 A1
(43) Pub. Date: Jan. 11, 2024

(54) Porous Silicon-Based Composite, Preparation Method Therefor, And Anode Active Material Comprising Same

(71) Applicant: DAEJOO ELECTRONIC MATERIALS CO., LTD., Siheung-si, Gyeonggi-do (KR)

(72) Inventors: Hyun Seok LEE, Siheung-si, Gyeonggi-do (KR); Jeong Gyu PARK, Siheung-si, Gyeonggi-do (KR); Young Min JEON, Siheung-si, Gyeonggi-do (KR); Hyun Hee LIM, Siheung-si, Gyeonggi-do (KR); Eo Rang LEE, Siheung-si, Gyeonggi-do (KR); Jong Chan LIM, Siheung-si, Gyeonggi-do (KR); Jung Hyun LEE, Siheung-si, Gyeonggi-do (KR)

(73) Assignee: DAEJOO ELECTRONIC MATERIALS CO., LTD., Siheung-si, Gyeonggi-do (KR)

(21) Appl. No.: 18/253,100

(22) PCT Filed: Nov. 2, 2021
(86) PCT No.: PCT/KR2021/015718

§ 371 Date: May 16, 2023

(30) Foreign Application Priority Data
Nov. 16, 2020 (KR) 10-2020-0152974

(51) Int. Cl. C01B 33/22; H01M 10/052

(52) U.S. Cl. CPC C01B 33/22; H01M 10/052; C01P 2006/40; C01P 2006/12; C01P 2004/61; C01P 2002/60; C01P 2002/74; C01P 2006/14; C01P 2004/03

(57) ABSTRACT

The present invention relates to a porous silicon-based composite, a preparation method therefor, and an anode active material comprising same, and, more specifically, the porous silicon-based composite comprises silicon particles and fluoride, and thus a porous silicon-based composite with excellent selective etching efficiency can be obtained, and the anode active material comprising same can further improve a discharge capacity and a capacity retention while holding the excellent initial efficiency of a secondary battery.

### TECHNICAL FIELD

The present invention relates to a porous silicon-based composite, to a process for preparing the same, and to a negative electrode active material comprising the same.

### BACKGROUND ART

In recent years, as electronic devices become smaller, lighter, thinner, and more portable in tandem with the development of the information and communication industry, the demand for a high energy density of batteries used as power sources for these electronic devices is increasing. A lithium secondary battery is a battery that can best meet this demand, and research on small batteries using the same, as well as the application thereof to large electronic devices such as automobiles and power storage systems, is being actively conducted.

Carbon materials are widely used as a negative electrode active material for such a lithium secondary battery. Silicon-based negative electrode active materials are being studied in order to further enhance the capacity of batteries. Since the theoretical capacity of silicon (4,199 mAh/g) is greater than that of graphite (372 mAh/g) by 10 times or more, a significant enhancement in the battery capacity is expected.

The reaction scheme when lithium is intercalated into silicon is, for example, as follows:

22Li+5Si═Li₂₂Si₅ [Reaction Scheme 1]

In a silicon-based negative electrode active material according to the above reaction scheme, an alloy containing up to 4.4 lithium atoms per silicon atom with a high capacity is formed. However, in most silicon-based negative electrode active materials, volume expansion of up to 300% is induced by the intercalation of lithium, which destroys the negative electrode, making it difficult to exhibit high cycle characteristics.

In addition, this volume change may cause cracks on the surface of the negative electrode active material, and an ionic material may be formed inside the negative electrode active material, thereby causing the negative electrode active material to be electrically detached from the current collector. This electrical detachment phenomenon may significantly reduce the capacity retention rate of a battery.

In order to solve this problem, Japanese Patent No. 4393610 discloses a negative electrode active material in which silicon and carbon are mechanically processed to form a composite, and the surfaces of the silicon particles are coated with a carbon layer using a chemical vapor deposition (CVD) method.

In addition, Japanese Laid-open Patent Publication No. 2016-502253 discloses a negative electrode active material comprising porous silicon-based particles and carbon particles, wherein the carbon particles comprise fine carbon particles and coarse-grained carbon particles having different average particle diameters.

However, although these prior art documents relate to a negative electrode active material comprising silicon and carbon, there is a limit to suppressing the volume expansion and contraction during charging and discharging. Thus, there is still a demand for research to solve these problems.

### PRIOR ART DOCUMENTS

### Patent Documents

(Patent Document 1) Japanese Patent No. 4393610
(Patent Document 2) Japanese Laid-open Patent Publication No. 2016-502253
(Patent Document 3) Korean Laid-open Patent Publication No. 2015-0113770
(Patent Document 4) Korean Laid-open Patent Publication No. 2015-0113771
(Patent Document 5) Korean Laid-open Patent Publication No. 2018-0106485

### DETAILED DESCRIPTION OF THE INVENTION

### Technical Problem

An object of the present invention is to provide a porous silicon-based composite having excellent selective etching efficiency and capable of further enhancing the performance of a secondary battery as it comprises silicon particles and a fluoride.

Another object of the present invention is to provide a process for preparing the porous silicon-based composite.

Still another object of the present invention is to provide a porous silicon-based-carbon composite comprising the porous silicon-based composite and carbon.

Still another object of the present invention is to provide a negative electrode active material that can further enhance discharge capacity and capacity retention rate while maintaining the excellent initial efficiency of a secondary battery as it comprises the porous silicon-based composite and a carbon-based negative electrode material, and a lithium secondary battery comprising the same.

### Solution to the Problem

The present invention provides a porous silicon-based composite comprising silicon particles and a fluoride.

In addition, the present invention provides a process for preparing the porous silicon-based composite, which comprises a first step of obtaining a silicon composite oxide powder using a silicon-based raw material and a metal-based raw material; and a second step of etching the silicon composite oxide powder using an etching solution comprising a fluorine (F) atom-containing compound.

In addition, the present invention provides a porous silicon-based-carbon composite, which comprises the porous silicon-based composite and carbon.

In addition, the present invention provides a negative electrode active material comprising the porous silicon-based composite and a carbon-based negative electrode material.

Further, the present invention provides a lithium secondary battery comprising the negative electrode active material.

### Advantageous Effects of the Invention

As the porous silicon-based composite according to the embodiment comprises silicon particles and a fluoride, it is possible to provide a porous silicon-based composite having excellent selective etching efficiency. When the porous silicon-based composite is applied to a negative electrode active material, discharge capacity and capacity retention rate can be further enhanced while maintaining the excellent initial efficiency of a secondary battery.

In addition, the process according to the embodiment has an advantage in that mass production is possible through a continuous process with minimized steps.

### BRIEF DESCRIPTION OF THE DRAWINGS

The following drawings attached to the present specification illustrate preferred embodiments of the present invention and serve to further understand the technical idea of the present invention together with the description of the present invention. Accordingly, the present invention should not be construed as being limited only to those depicted in the drawings.

FIG. 1 is a result of observing the surface of the porous silicon-based composite (composite B1) prepared in Example 1 using a scanning electron microscope (FE-SEM) photograph (S-4700, Hitachi). FIGS. 1(a) and 1(b) are shown at different magnifications of 500 times and 25,000 times, respectively.

FIG. 2 is a result of observing the surface of the porous silicon-based composite (composite B4) prepared in Example 4 using a scanning electron microscope (FE-SEM) photograph (S-4700, Hitachi). FIGS. 2(a) and 2(b) are shown at different magnifications of 1,000 times and 250,000 times, respectively.

FIG. 3 is a result of observing the inside of the porous silicon-based composite (composite B4) prepared in Example 4 using an ion beam scanning electron microscope photograph (FIB-SEM, S-4700; Hitachi, QUANTA 3D FEG; FEI) at a magnification of 200,000 times.

FIG. 4 shows the measurement results of an X-ray diffraction analysis of the silicon composite oxide (composite A1) (a) and the porous silicon-based composite (composite B1) (b) of Example 1.

FIG. 5 shows the measurement results of an X-ray diffraction analysis of the porous silicon-based composite (composite B5) of Example 5.

FIG. 6 shows the measurement results of an X-ray diffraction analysis of the porous silicon-based composite (composite B8) of Example 8.

FIG. 7 shows the measurement results of a specific surface area (Brunauer-Emmett-Teller Method; BET) analysis of the porous silicon-based composite (composite B3) of Example 3.

### BEST MODE FOR CARRYING OUT THE INVENTION

The present invention is not limited to what is disclosed below. Rather, it may be modified in various forms as long as the gist of the invention is not altered.

In this specification, when a part is referred to as “comprising” an element, it is to be understood that the part may comprise other elements as well, unless otherwise indicated.

In addition, all numbers and expressions related to the quantities of components, reaction conditions, and the like used herein are to be understood as being modified by the term “about,” unless otherwise indicated.

[Porous Silicon-Based Composite]

The porous silicon-based composite according to an embodiment of the present invention comprises silicon particles and a fluoride.

As the porous silicon-based composite according to an embodiment comprises silicon particles and a fluoride together, it is possible to provide a porous silicon-based composite having excellent selective etching efficiency.

In addition, when the porous silicon-based composite is applied to a negative electrode active material, lithium does not react and lithium ions are not rapidly charged in the fluoride during charging when lithium ions are charged and discharged from the silicon particles; thus, the volume expansion of silicon particles can be suppressed when a secondary battery is charged. Therefore, a negative electrode active material comprising the porous silicon-based composite is capable of further enhancing discharge capacity and capacity retention rate while maintaining excellent initial efficiency.

In particular, since the porous silicon-based composite is porous, that is, it comprises pores, the volume expansion of a negative electrode active material during charging and discharging can be minimized, and the lifespan characteristics of a secondary battery can be enhanced at the same time. In addition, since the pores can be impregnated with a non-electrolyte, lithium ions can penetrate into the inside of the porous silicon-based composite, which allows the efficient diffusion of lithium ions, so that high charging and discharging rates can be achieved. Thus, the porous silicon-based composite can be advantageously used in the preparation of a negative electrode active material for a lithium secondary battery and a lithium secondary battery comprising the same.

Hereinafter, each component of the porous silicon-based composite will be described in detail.

Silicon Particles

The porous silicon-based composite according to an embodiment of the present invention comprises silicon particles that can react with lithium.

Since the silicon particles charge lithium, the capacity of a secondary battery may decrease if silicon particles are not employed. The silicon particles may be crystalline or amorphous and specifically may be amorphous or in a similar phase thereto. If the silicon particles are crystalline, as the size of the crystallites is small, the density of the matrix may be enhanced and the strength may be fortified to prevent cracks. Thus, the initial efficiency or cycle lifespan characteristics of the secondary battery can be further enhanced. In addition, if the silicon particles are amorphous or in a similar phase thereto, the expansion or contraction during charging and discharging of the lithium secondary battery is small, and battery performance such as capacity characteristics can be further enhanced.

Although the silicon particles have high initial efficiency and battery capacity together, it is accompanied by a very complex crystal change by electrochemically absorbing, storing, and releasing lithium atoms. In the porous silicon-based composite according to an embodiment of the present invention, the silicon particles may have a crystallite size of 1 nm to 30 nm upon an X-ray diffraction analysis (converted from the X-ray diffraction analysis result).

Specifically, when it is subjected to an X-ray diffraction (Cu-Kα) analysis using copper as a cathode target and calculated by the Scherrer equation based on a full width at half maximum (FWHM) of the diffraction peak of Si (220) around 2θ=47.5°, the silicon particles may have a crystallite size of 1 nm to 30 nm, preferably, 1 nm to 15 nm, more preferably, 2 nm to 10 nm.

If the crystallite size of the silicon particles is less than 1 nm, it is not easy to prepare them, and the yield after etching may be low. In addition, if the crystallite size exceeds 30 nm, the micropores cannot adequately suppress the volume expansion of silicon particles that occur during charging and discharging, a region that does not contribute to discharging is present, and a reduction in the Coulombic efficiency that stands for the ratio of charge capacity to discharge capacity cannot be suppressed.

In addition, the silicon particles contained in the porous silicon-based composite may further comprise amorphous silicon particles.

If the silicon particles are made even smaller such that they are amorphous or have a crystallite size of 1 nm to 6 nm, pores in the porous silicon-based composite can be significantly reduced. As a result, the strength of the matrix is fortified to prevent cracks; thus, the initial efficiency or cycle lifespan characteristics of a secondary battery may be further enhanced.

The porous silicon-based composite is a composite in which a plurality of silicon particles are uniformly distributed in a composite whose structure is in the form of a single mass, for example, a polyhedral, spherical, or similar shape. In addition, the porous silicon-based composite may have a three-dimensional structure that comprises secondary silicon particles (silicon aggregate) formed by combining two or more silicon particles (primary silicon particles) with each other.

The content of silicon (Si) in the porous silicon-based composite may be 30% by weight to 99% by weight, preferably, 30% by weight to 85% by weight, more preferably, 40% by weight to 70% by weight, based on the total weight of the porous silicon-based composite.

If the content of silicon (Si) is less than 30% by weight, the amount of an active material for occlusion and release of lithium is small, which may reduce the charge and discharge capacity of a lithium secondary battery. On the other hand, if it exceeds 99% by weight, the charging and discharge capacity of a lithium secondary battery may be increased, whereas the expansion and contraction of the electrode during charging and discharging may be excessively increased, and the negative electrode active material powder may be further atomized, which may deteriorate the cycle characteristics.

Fluoride

The porous silicon-based composite according to an embodiment of the present invention comprises a fluoride.

Since the fluoride is disposed adjacent to the silicon particles, the contact of the silicon particles with the electrolyte solvent is minimized, and the reaction between silicon and the electrolyte solvent is minimized, whereby it is possible to prevent a decrease in the initial charge and discharge efficiency and to suppress the expansion of silicon, thereby enhancing the capacity retention rate.

Specifically, the fluoride may comprise a metal fluoride.

The preferable characteristics of the porous silicon-based composite that comprises a fluoride, for example, a metal fluoride, according to an embodiment of the present invention will be described below.

In general, silicon particles may occlude lithium ions during the charging of a secondary battery to form an alloy, which may increase the lattice constant to thereby expand the volume thereof. In addition, during the discharging of a secondary battery, lithium ions are released to return to the original metal nanoparticles, thereby reducing the lattice constant.

The metal fluoride may be considered as a zero-strain material that does not accompany a change in the crystal lattice constant while lithium ions are occluded and released. The silicon particles may be present between the metal fluoride particles and may be surrounded by the metal fluoride.

Meanwhile, the metal fluoride does not release lithium ions during the charging of a lithium secondary battery. For example, it is also an inactive material that does not occlude or release lithium ions during the charging of a lithium secondary battery.

That is, in the porous silicon-based composite, lithium ions are released from the silicon particles, whereas lithium ions, which have been steeply increased during charging, are not released from the metal fluoride. Thus, a porous matrix comprising a metal fluoride does not participate in the chemical reaction of a battery, but it is expected to function as a body that suppresses the volume expansion of silicon particles during the charging of the secondary battery.

The silicon particles may be present between the metal fluoride particles and may be surrounded by the metal fluoride.

In the metal fluoride, the metal may be at least one selected from the group consisting of alkali metals, alkaline earth metals, Groups 13 to 16 elements, transition metals, rare earth elements, and combinations thereof. Specific examples thereof may include Mg, Li, Na, K, Ca, Sr, Ba, Y, Ti, Zr, Hf, V, Nb, Cr, Mo, W, Fe, Pb, Ru, Ir, Pd, Pt, Cu, Ag, Au, Zn, Cd, B, Al, Ga, Sn, In, Ge, P, As, Sb, Bi, S, and Se.

More specifically, the metal may comprise at least one selected from the group consisting of Mg, Li, Na, K, Ca, Sr, Ba, Ti, Zr, B, and Al. It may comprise, for example, Mg. For example, the porous silicon-based composite may comprise fluorine-containing magnesium compound.

The fluorine-containing magnesium compound may comprise magnesium fluoride (MgF₂), magnesium fluoride silicate (MgSiF₆), or a mixture thereof. When the magnesium fluoride is subjected to an X-ray diffraction (Cu-Kα) analysis using copper as a cathode target and calculated by the Scherrer equation based on a full width at half maximum (FWHM) of the diffraction peak of MgF₂ (111) around 2θ=40°, MgF₂ may have a crystallite size of 3 nm to 35 nm, preferably, 3 nm to 25 nm, more preferably, 5 nm to 22 nm. If the crystallite size of MgF₂ is within the above range, it may function as a body for suppressing the volume expansion of silicon particles during the charging and discharging of a lithium secondary battery.

According to an embodiment of the present invention, when the porous silicon-based composite is subjected to an X-ray diffraction analysis, it may have an IB/IA, as a ratio of the diffraction peak intensity (IB) corresponding to an MgF₂ (111) crystal plane of the magnesium fluoride to the diffraction peak intensity (IA) of an Si (220) crystal plane, of greater than 0 to 1.0. Specifically, in an X-ray diffraction (Cu-Kα) analysis using copper corresponding to an Si (220) crystal plane of the silicon particles as a cathode target, IB/IA, as a ratio of the diffraction peak intensity (IB) corresponding to an MgF₂ (111) crystal plane around 2θ=40.4° to the diffraction peak intensity (IA) of Si (220) around 2θ=47.3°, may be greater than 0 to 1.0, preferably, 0.05 to 0.7, more preferably, 0.05 to 0.5, even more preferably, 0.1 to 0.5.

If IB/IA exceeds 1.0, there may be a problem in that the capacity of a secondary battery is deteriorated.

The content of metals in the porous silicon-based composite may be 0.2% by weight to 20% by weight, preferably, 0.2% by weight to 15% by weight, more preferably, 0.2% by weight to 10% by weight or 0.2% by weight to 6% by weight, based on the total weight of the porous silicon-based composite. If the content of metals in the porous silicon-based composite is less than 0.2% by weight, there may be a problem in that the cycle characteristics of a secondary battery are reduced. If it exceeds 20% by weight, there may be a problem in that the charge capacity of a secondary battery is reduced. For example, the content of magnesium in the porous silicon-based composite may be 0.2% by weight to 20% by weight, preferably, 0.2% by weight to 15% by weight, more preferably, 0.2% by weight to 10% by weight or 0.2% by weight to 8% by weight, based on the total weight of the porous silicon-based composite.

Meanwhile, according to an embodiment of the present invention, the molar ratio of metal atoms to silicon atoms present in the porous silicon-based composite, for example, the molar ratio of magnesium atoms to silicon atoms (Mg/Si), may be 0.01 to 0.30. If the molar ratio of Mg/Si is controlled within the above range, it does not act as resistance during the intercalation reaction of lithium. As a result, when the composite is applied to a negative electrode active material, it is likely that there will be produced an effect that the electrochemical characteristics of a lithium secondary battery are not deteriorated. The molar ratio of Mg/Si present in the composite may be 0.01 to 0.30, more preferably, 0.02 to 0.15, even more preferably 0.02 to 0.10.

In the porous silicon-based composite according to an embodiment of the present invention, silicon dioxide is removed through a selective etching process, whereby the number of oxygen may be lowered. That is, it is preferable to adjust the molar ratio of Mg/Si within the above range by lowering the oxygen content of the porous silicon-based composite. In such a case, it is possible to significantly lower the oxygen fraction of the surface of the porous silicon-based composite and to reduce the surface resistance thereof. As a result, when the composite is applied to a negative electrode active material, the electrochemical properties, particularly, lifespan characteristics of a lithium secondary battery can be remarkably improved.

Thus, as the molar ratio of Mg/Si in the porous silicon-based composite is controlled within the above range, the initial charge and discharge and capacity retention rate may be further enhanced.

The content of the metal fluoride may be 0.04 to 40.0% by weight, 0.5 to 25.0% by weight, or 1 to 15% by weight, based on the total weight of the porous silicon-based composite. If the content of the metal fluoride satisfies the above range, the cycle characteristics and capacity characteristics of a secondary battery may be further enhanced.

For example, the content of the fluorine-containing magnesium compound may be 0.04 to 20.9% by weight, 0.5 to 15.0% by weight, or 1.0 to 12.0% by weight, based on the total weight of the porous silicon-based composite.

Metal Silicate

The porous silicon-based composite may further comprise a metal silicate. In such an event, the metal may be the same as the type of metal in the metal fluoride described above. The metal silicate may comprise, for example, magnesium silicate.

The magnesium silicate may comprise MgSiO₃ crystals, Mg₂SiO₄ crystals, or a mixture thereof.

In particular, as the porous silicon-based composite comprises MgSiO₃ crystals, the Coulombic efficiency or capacity retention rate may be increased.

The content of the magnesium silicate may be 0 to 46% by weight, 0.5 to 30% by weight, or 0.5 to 25% by weight, based on the total weight of the porous silicon-based composite. For example, the content of the magnesium silicate may be 0 to 30% by weight, 0.5 to 25% by weight, or 0.5 to 20% by weight, based on the total weight of the porous silicon-based composite.

According to an embodiment of the present invention, in the porous silicon-based composite, the metal silicate may be converted to a metal fluoride by etching.

For example, some, most, or all of the metal silicate may be converted to a metal fluoride depending on the etching method or etching degree. More specifically, most of the metal silicate may be converted to a metal fluoride.

Silicon Oxide Compound

The porous silicon-based composite may further comprise a silicon oxide compound.

The silicon oxide compound may be a silicon-based oxide represented by the formula SiOₓ (0.5≤x≤2). The silicon oxide compound may be specifically SiOₓ (0.8≤x≤1.2), more specifically SiOₓ (0.9<x≤1.1). In the formula SiOₓ, if the value of x is less than 0.5, expansion or contraction may be increased and lifespan characteristics may be deteriorated during the charging and discharging of a secondary battery. In addition, if x exceeds 2, there may be a problem in that the initial efficiency of a secondary battery is decreased as the amount of inactive oxides increases.

The silicon oxide compound may be employed in an amount of 0.1% by weight to 45% by weight, preferably, 0.1% by weight to 35% by weight, more preferably, 0.1% by weight to 20% by weight, based on the total weight of the porous silicon-based composite.

If the content of the silicon oxide compound is less than 0.1% by weight, the volume of a secondary battery may expand, and the lifespan characteristics thereof may be deteriorated. On the other hand, if the content of the silicon oxide compound exceeds 45% by weight, the initial irreversible reaction of a secondary battery may be increased, thereby deteriorating the initial efficiency.

Pores

The porous silicon-based composite according to an embodiment of the present invention may have a porous structure that comprises pores on its surface, inside, or both.

In the porous silicon-based composite, the volume expansion that takes place during the charging and discharging of a secondary battery is concentrated on the pores rather than the outer part of the negative electrode active material, thereby effectively controlling the volume expansion and enhancing the lifespan characteristics of the lithium secondary battery. In addition, since the pores can be impregnated with a non-electrolyte, lithium ions can penetrate into the inside of the porous silicon-based composite, which expedites the efficient diffusion of lithium ions, so that high charging and discharging rates can be achieved.

In the present specification, pores may be used interchangeably with voids. In addition, the pores may comprise open pores, closed pores, or both. The closed pores refer to independent pores that are not connected to other pores because all of the walls of the pores are formed in a closed structure. In addition, the open pores are formed in an open structure in which at least a part of the walls of the pores are open, so that they may be, or may not be, connected to other pores. In addition, they may refer to pores exposed to the outside as they are disposed on the surface of the silicon-based composite.

According to an embodiment of the present invention, the porosity and pore distribution of the porous silicon-based composite and the formation of open pores present on the surface of the silicon-based composite were measured by a gas adsorption method (BET plot method).

In addition, open pores can be identified as pore volume by gas adsorption behavior, and closed pores can be observed through electron microscopy or transmission electron microscopy (TEM) by cutting the particles.

The porous silicon-based composite preferably has a pore volume (cc/g) in the range of 0.1 to 0.9 cc/g. If the pore volume is less than 0.1 cc/g, the volume expansion of a negative electrode active material cannot be suppressed during charging and discharging. If it exceeds 0.9 cc/g, the mechanical strength is reduced due to a large number of pores present in the negative electrode active material, so that there is a concern that the negative electrode active material may be collapsed in the process of manufacturing a secondary battery (during the mixing of a slurry, pressing after coating, and the like).

If the pore volume satisfies the above range, a buffering effect of volume expansion may be produced while sufficient mechanical strength is maintained. It may be preferably 0.2 cc/g to 0.8 cc/g, more preferably 0.2 cc/g to 0.7 cc/g. If the above range is satisfied, the volume expansion of a negative electrode active material during charging and discharging may be minimized or mitigated, whereby the lifespan characteristics of a secondary battery may be simultaneously enhanced.

In addition, as the porous silicon-based composite comprises pores satisfying the above range of pore volume, it is possible to solve the difficulty in electrical contact between particles and to further enhance the performance of a lithium secondary battery even after the electrode expands due to repeated charging and discharging.

In addition, it is preferable that the silicon particles in the porous silicon-based composite comprising the pores are uniformly distributed in the composite. As a result, it can have excellent mechanical properties such as strength. In addition, since it has a porous structure, it is possible to accommodate the volume expansion of silicon particles taking place during the charging and discharging of a secondary battery, thereby effectively mitigating and suppressing a problem caused by the volume expansion.

The porosity of the porous silicon-based composite may be 10% by volume to 80% by volume, preferably, 15% by volume to 70% by volume, more preferably, 20% by volume to 60% by volume, based on the volume of the porous silicon-based composite. The porosity may be a porosity of the closed pores and open pores in the porous silicon-based composite.

Here, porosity refers to “(pore volume per unit mass)/{(specific volume+pore volume per unit mass)}.” It may be measured by a mercury porosimetry method or a Brunauer-Emmett-Teller (BET) measurement method.

In the present specification, the specific volume is calculated as 1/(particle density) of a sample. The pore volume per unit mass is measured by the BET method to calculate the porosity (%) from the above equation.

If the porosity of the porous silicon-based composite satisfies the above range, it is possible to obtain a buffering effect of volume expansion while maintaining sufficient mechanical strength when it is applied to a negative electrode active material of a secondary battery. Thus, it is possible to minimize the problem of volume expansion due to the use of silicon particles, to achieve high capacity, and to enhance lifespan characteristics. If the porosity of the porous silicon-based composite is less than 10% by volume, it may be difficult to control the volume expansion of the negative electrode active material during charging and discharging. If it exceeds 80% by volume, the mechanical strength is reduced due to a large number of pores present in the negative electrode active material, and there is a concern that the negative electrode active material may be collapsed in the process of manufacturing a secondary battery, for example, during the mixing of the negative electrode active material slurry and the rolling step after coating.

The porous silicon-based composite may comprise a plurality of pores, and the diameters of the pores may be the same as, or different from, each other.

When the surface of the porous silicon-based composite is measured by a gas adsorption method (BET plot method), it may comprise micropores of 2 nm or less; mesopores of greater than 2 nm to 50 nm; and macropores of greater than 50 nm to 250 nm. In addition, the total volume of the mesopores may be 30% by volume to 80% by volume based on the total volume of the entire pores. In addition, the total volume of the macropores may be 1% by volume to 25% by volume based on the total volume of the entire pores.

Meanwhile, the ratio of micropores and mesopores in the porous silicon-based composite relative to the entire pores may be 75% by volume to 98% by volume. If the pores are uniformly dispersed in the silicon-based composite, excellent mechanical properties, that is, high strength can be provided despite the presence of the pores. As a result, when it is applied to a negative electrode active material of a secondary battery, it is possible to remarkably enhance the charge and discharge capacity, initial charge and discharge efficiency, and capacity retention rate thereof.

It can be seen that the pore volume of the porous silicon-based composite according to an embodiment of the present invention is highly related to the specific surface area (Brunauer-Emmett-Teller Method; BET) value of the porous silicon-based composite. That is, the specific surface area tends to decrease proportionally with a decrease in the pore volume.

The porous silicon-based composite may have a specific surface area (Brunauer-Emmett-Teller method; BET) of 50 m²/g to 1,500 m²/g, preferably, 100 m²/g to 1,200 m²/g or 200 m²/g to 900 m²/g. If the specific surface area of the porous silicon-based composite is less than 50 m²/g, the volume expansion of the composite cannot be suppressed during charging and discharging. If it exceeds 1,500 m²/g, the mechanical strength is deteriorated due to a large number of pores present in the porous silicon-based composite, which may cause a problem in that the composite may be destroyed during the manufacturing process of a secondary battery, and cracks may be formed during charging and discharging.

If the specific surface area of the porous silicon-based composite satisfies the above range, it may indicate that silicon particles are uniformly dispersed in the composite. In addition, as the specific surface area increases within the above range, the crystallite size of the silicon particles may decrease. For example, the closer the specific surface area is to 1,500 m²/g, the closer the crystallite size of the silicon particles is to 1 nm.

The porous silicon-based composite may have a specific gravity of 1.6 g/cm³ to 2.6 g/cm³, specifically, 1.7 g/cm³ to 2.5 g/cm³, more specifically, 1.8 g/cm³ to 2.5 g/cm³.

If the specific gravity of the porous silicon-based composite satisfies the above range, it is preferable since strength is enhanced, and initial efficiency or cycle lifespan characteristics are enhanced.

If the specific gravity of the porous silicon-based composite is 1.6 g/cm³ or more, the dissociation between the negative electrode active material powder due to volume expansion of the negative electrode active material powder during charging may be prevented, and the cycle deterioration may be suppressed. If the specific gravity is 2.6 g/cm³ or less, the impregnability of an electrolyte is enhanced, which increases the utilization rate of the negative electrode active material, so that the initial charge and discharge capacity can be enhanced.

In particular, when the specific gravity is 1.7 g/cm³ to 2.5 g/cm³, high battery capacity in the range of 1,500 to 3,000 mAh/g may be achieved, along with enhanced Coulombic efficiency. Even when used in combination with graphite-based materials having low volume expansion, the silicon particles do not cause large volume expansion, thereby causing little separation between the graphite material and the silicon particles; thus, a secondary battery with excellent cycle characteristics can be obtained.

Here, specific gravity may refer to particle density, density, or true density. According to an embodiment of the present invention, for the measurement of specific gravity, for example, for the measurement of specific gravity by a dry density meter, Acupick II1340 manufactured by Shimadzu Corporation may be used as a dry density meter. The purge gas to be used may be helium gas, and the measurement may be carried out after 200 times of purge in a sample holder set at a temperature of 23° C.

The porosity can be changed by an etching rate, the content of each component, and various etching methods. In addition, the porosity and pore size of the closed pores can be measured using a transmission electron microscope (TEM).

The porous silicon-based composite may have an average diameter (average size) of pores of 0.1 nm to 50 nm. The average diameter of pores may refer to an average diameter of closed pores, open pores, or both.

For example, if the average diameter of closed pores is 0.1 nm or more, an electrolyte solution can penetrate in a timely manner, so that the initial activation of a negative electrode active material is possible, and an appropriate space for mitigating volume expansion can be secured. In addition, if the average diameter of closed pores is 50 nm or less, it is possible to prevent the silicon particles and fluoride, specifically, a metal fluoride, from being detached from the porous silicon-based composite during charging and discharging.

If the average diameter of open pores exceeds 50 nm, there may be a problem in that the energy density of a negative electrode active material may decrease due to the presence of extra pores or voids. In addition, mechanical strength is deteriorated due to the large number of open pores present in the porous silicon-based composite, so that the negative electrode active material may be destroyed during the manufacturing process of a battery, such as mixing of a slurry, coating and rolling, and the like. In addition, if the average diameter of open pores is less than 0.1 nm, the effect of the suppressing volume expansion of a negative electrode active material during charging and discharging may be insignificant.

Specifically, the average diameter of pores of the porous silicon-based composite may be more preferably 1.0 nm to 30 nm. The average diameter of pores may refer to an average diameter of closed pores, open pores, or both.

As the porous silicon-based composite maintains an average pore diameter within the above range even after the charging and discharging of a lithium secondary battery, a more excellent buffering effect can be produced during the volume expansion or contraction of the negative electrode active material.

[Porous Silicon-Based-Carbon Composite]

The present invention, according to an embodiment, may provide a porous silicon-based-carbon composite, which comprises the porous silicon-based composite and carbon.

The porous silicon-based composite contained in the porous silicon-based-carbon composite is as described above.

Carbon

The porous silicon-based-carbon composite according to an embodiment of the present invention comprises carbon.

According to an embodiment of the present invention, as the porous silicon-based-carbon composite comprises carbon, it is possible to secure adequate electrical conductivity of the porous silicon-based-carbon composite and to adjust the specific surface area appropriately. Thus, when it is used as a negative electrode active material of a secondary battery, the lifespan characteristics and capacity of the secondary battery can be enhanced.

In general, the electrical conductivity of a negative electrode active material is an important factor for facilitating electron transfer during an electrochemical reaction. If the composite as a negative electrode active material does not comprise carbon, for example, when a high-capacity negative electrode active material is prepared using silicon particles and a metal fluoride, the electrical conductivity may not reach an appropriate level.

Thus, the present inventors have formed a carbon layer on the surface of a porous silicon-based composite comprising silicon particles and a fluoride (for example, a metal fluoride), whereby it is possible to improve the charge and discharge capacity, initial charge efficiency, and capacity retention rate, to enhance the mechanical properties, to impart excellent electrical conductivity even after charging and discharging have been carried out and the electrode has been expanded, to suppress the side reaction of the electrolyte, and to further enhance the performance of the lithium secondary battery.

The porous silicon-based-carbon composite comprises a carbon layer on the surface of the silicon-based composite, and the carbon is present on a part or the entirety of the surfaces of the silicon particles and the fluoride to form a carbon layer.

In addition, according to an embodiment of the present invention, the thickness of the carbon layer or the amount of carbon may be controlled, so that it is possible to achieve appropriate electrical conductivity, as well as to prevent a deterioration of the lifespan characteristics, to thereby achieve a high-capacity negative electrode active material.

The porous silicon-based-carbon composite on which a carbon layer is formed may have an average particle diameter (D₅₀) of 1 μm to 20 μm. In addition, the average particle diameter is a value measured as a volume average D₅₀, i.e., a particle diameter or median diameter when the cumulative volume is 50% in particle size distribution measurement according to a laser beam diffraction method. Specifically, the average particle diameter (D₅₀) of the porous silicon-based-carbon composite may be 1 μm to 20 μm, 3 μm to 10 μm, or 3 μm to 8 μm. If the average particle diameter of the porous silicon-based-carbon composite is less than 1 μm, there is a concern that the dispersibility may be deteriorated due to the aggregation of particles of the composite during the preparation of a negative electrode slurry (i.e., a negative electrode active material composition) using the same. In addition, if the average particle diameter of the porous silicon-based-carbon composite exceeds 20 μm, the expansion of the composite particles due to the charging of lithium ions becomes severe, and the binding capability between the particles of the composite and the binding capability between the particles and the current collector are deteriorated as charging and discharging are repeated, so that the lifespan characteristics may be significantly reduced. In addition, there is a concern that the activity may be deteriorated due to a decrease in the specific surface area.

According to an embodiment, the content of carbon (C) may be 3% by weight to 80% by weight, 3% by weight to 50% by weight, or 10% by weight to 30% by weight, based on the total weight of the porous silicon-based-carbon composite.

If the content of carbon (C) is less than 3% by weight, a sufficient effect of enhancing conductivity cannot be expected, and there is a concern that the electrode lifespan of a lithium secondary battery may be deteriorated. In addition, if it exceeds 80% by weight, the discharge capacity of a secondary battery may decrease and the bulk density may decrease, so that the charge and discharge capacity per unit volume may be deteriorated.

The carbon layer may have an average thickness of 1 nm to 300 nm, specifically, nm to 200 nm or 10 nm to 150 nm, more specifically, 10 nm to 100 nm. If the thickness of the carbon layer is 1 nm or more, an enhancement in conductivity may be achieved. If it is 300 nm or less, a decrease in the capacity of a secondary battery may be suppressed.

The average thickness of the carbon layer may be measured, for example, by the following procedure.

First, a negative electrode active material is observed at an arbitrary magnification by a transmission electron microscope (TEM). The magnification is preferably, for example, a degree that can be confirmed with the naked eye. Subsequently, the thickness of the carbon layer is measured at arbitrary 15 points. In such an event, it is preferable to select the measurement positions at random widely as much as possible, without concentrating on a specific region. Finally, the average value of the thicknesses of the carbon layer at the 15 points is calculated.

The carbon layer may comprise at least one selected from the group consisting of graphene, reduced graphene oxide, a carbon nanotube, a carbon nanofiber, and graphite.

[Process for Preparing the Porous Silicon-Based Composite]

The process for preparing the porous silicon-based composite according to an embodiment of the present invention comprises a first step of obtaining a silicon composite oxide powder using a silicon-based raw material and a metal-based raw material; and a second step of etching the silicon composite oxide powder using an etching solution comprising a fluorine (F) atom-containing compound.

The process according to an embodiment has an advantage in that mass production is possible through a continuous process with minimized steps.

Specifically, in the process for preparing the porous silicon-based composite, the first step may comprise obtaining a silicon composite oxide powder using a silicon-based raw material and a metal-based raw material.

The silicon-based raw material may comprise at least one selected from the group consisting of a silicon powder, a silicon oxide powder, and a silicon dioxide powder.

The metal in the metal-based raw material is as described above.

The first step may be carried out by, for example, using the method described in Korean Laid-open Patent Publication Nos. 2015-0113770, 2015-0113771, or 2018-0106485.

In addition, the silicon composite oxide may comprise a compound represented by the following Formula 1.

MₓSiO_{y} [Formula 1]

in Formula 1, M comprises a metal, x is greater than 0 to 2, and y is greater than 0.02 to less than 4.

Specifically, M may be at least one selected from the group consisting of alkali metals, alkaline earth metals, Groups 13 to 16 elements, transition metals, rare earth elements, and combinations thereof. Specific examples thereof may include Mg, Li, Na, K, Ca, Sr, Ba, Y, Ti, Zr, Hf, V, Nb, Cr, Mo, W, Fe, Pb, Ru, Ir, Pd, Pt, Cu, Ag, Au, Zn, Cd, B, Al, Ga, Sn, In, Ge, P, As, Sb, Bi, S, and Se.

More specifically, M may comprise at least one selected from the group consisting of Mg, Li, Na, K, Ca, Sr, Ba, Ti, Zr, B, and A1. It may comprise, for example, Mg.

Preferably, in Formula 1, M may comprise Mg, x may be greater than 0 to less than 0.2, and y may be 0.8 to 1.2.

The silicon composite oxide may have a specific surface area (Brunauer-Emmett-Teller method; BET) of 3 m²/g to 30 m²/g, 3 m²/g to 10 m²/g, or 3 m²/g to 8 m²/g. If the specific surface area of the silicon composite oxide is less than 3 m²/g, the average particle diameter of the particles is too large. Thus, when it is applied to a current collector as a negative electrode active material of a secondary battery, an uneven electrode may be formed, which impairs the lifespan of the secondary battery. If it exceeds 30 m²/g, it is difficult to control the heat generated by the etching reaction in the second step.

According to an embodiment of the present invention, the process may further comprise forming a carbon layer on the surface of the silicon composite oxide by using a chemical thermal decomposition deposition method.

Specifically, once a carbon layer has been formed on the surface of the silicon composite oxide powder, the etching process of the second step may be carried out. In such a case, there is an advantage in that uniform etching is possible.

In the process for preparing the porous silicon-based-carbon composite, the second step may comprise etching the silicon composite oxide powder using an etching solution comprising a fluorine (F) atom-containing compound.

The etching step may comprise dry etching and wet etching.

If dry etching is used, selective etching may be possible.

Silicon dioxide of the silicon composite oxide powder is dissolved and eluted by the etching step to thereby form pores.

For example, the metal silicate is converted to a metal fluoride by the etching step, so that a porous silicon-based composite comprising silicon particles and a fluoride, specifically, a metal fluoride, more specifically, fluorine-containing magnesium compound, may be prepared.

The silicon composite oxide powder is etched using an etching solution comprising a fluorine (F) atom-containing compound in the etching step to thereby form pores.

If the silicon composite oxide powder is etched using a fluorine (F) atom-containing compound (e.g., HF), a part or most of the metal silicate, for example, magnesium silicate, is converted to a metal fluoride, for example, fluorine-containing magnesium compound, and pores are formed at the same time in the portion from which silicon dioxide has been eluted and removed. As a result, a porous silicon-based composite comprising silicon particles and a metal fluoride may be prepared.

For example, in the etching step in which HF is used, when dry etching is carried out, it may be represented by the following Reaction Schemes G1 and G2, and when wet etching is carried out, it may be represented by the following Reaction Schemes L1a to L2:

MgSi₃+6HF (gas)→SiF₄(g)+MgF₂+3H₂O (G1)

Mg₂SiO₄+8HF (gas)→SiF₄(g)+2MgF₂+4H₂O (G2)

MgSiO₃+6HF (aq. solution)→MgSiF₆+3H₂O (L1a)

MgSiF₆+2HF (aq. solution)→MgF₂+H₂SiF₆ (L1b)

MgSiO₃+2HF→SiO₂+MgF₂+H₂O (L1c)

SiO₂+6HF (l)→H₂SiF₆+2H₂O (L1d)

MgSiO₃+8HF (aq. solution)→MgF₂+H₂SiF₆+3H₂O (L1)

Mg₂SiO₄+8HF (aq. solution)→MgSiF₆+MgF₂+4H₂O (L2a)

MgSiF₆+2HF (aq. solution)→MgF₂+H₂SiF₆ (L2b)

Mg₂SiO₄₊₄HF (aq. solution)→SiO₂+2MgF₂+2H₂O (L2c)

SiO₂+6HF (aq. solution)→H₂SiF₆+2H₂O (L2d)

Mg₂SiO₄+10HF (aq. solution)→2MgF₂+H₂SiF₆+4H₂O (L2)

In addition, pores may be considered to be formed by the following Reaction Schemes (3) and (4).

SiO₂+4HF (gas)→SiF₄+2H₂O (3)

SiO₂+6HF (aq. solution)→H₂SiF₆+2H₂O (4)

Pores and voids may be formed where silicon dioxide is dissolved and removed in the form of SiF₄ and H₂SiF₆ by the reaction mechanism as in the above reaction schemes.

In addition, silicon dioxide contained in the porous silicon-based composite may be removed depending on the degree of etching, and pores may be formed therein.

The degree of formation of pores may vary with the degree of etching. For example, pores may be hardly formed, or pores may be partially formed, specifically, pores may be formed only in the outer portion.

According to an embodiment of the present invention, in the porous silicon-based composite, most of the metal silicate is converted to a metal fluoride, and silicon oxide is removed, by etching.

It is possible to obtain a porous silicon-based composite powder having a plurality of pores formed on the surface of the composite, or on the surface and inside thereof, through the etching. In addition, closed pores may be formed inside the porous silicon-based composite.

In addition, according to an embodiment, after the etching, crystals of both metal fluoride and metal silicate may be contained. In addition, the ratio of the metal silicate contained in the porous silicon-based composite may vary upon the etching.

Here, etching refers to a process in which the silicon composite oxide powder is treated with an etching solution containing a fluorine (F) atom-containing compound.

A commonly used etching solution may be used without limitation within a range that does not impair the effects of the present invention as the etching solution containing a fluorine (F) atom-containing compound.

In the second step, the etching solution may further comprise one or more acids selected from the group consisting of organic acids, sulfuric acid, hydrochloric acid, phosphoric acid, nitric acid, and chromic acid.

Specifically, the silicon composite oxide powder may be added to the etching solution containing an acid and an F atom-containing compound and then stirred. The stirring temperature (treatment temperature) is not particularly limited. For example, it may be 20° C. to 90° C.

Specifically, the fluorine (F) atom-containing compound may comprise at least one selected from the group consisting of HF, NH₄F, and HF₂. As the fluorine (F) atom-containing compound is used, the porous silicon-based composite may comprise a metal fluoride, or a metal fluoride and a metal silicate, and the etching step may be carried out more quickly.

Meanwhile, in the second step, the silicon composite oxide powder may be dispersed in a dispersion medium, and etching may be then carried out. The dispersion medium may comprise at least one selected from the group consisting of water, alcohol-based compounds, ketone-based compounds, ether-based compounds, hydrocarbon-based compounds, and fatty acids. In the silicon composite oxide powder, a part of silicon oxide may remain in addition to silicon dioxide, and the portion from which silicon dioxide is removed by the etching may form voids or pores inside the particles. In addition, most of the metal silicate reacts with fluorine (F) in the fluorine (F) atom-containing compound in the etching solution through the etching to form a metal fluoride.

The porous silicon-based composite obtained upon the etching may comprise silicon particles that are porous and a fluoride, specifically, a metal fluoride. In addition, the porous silicon-based composite may further comprise a metal silicate. For example, the porous silicon-based composite may comprise primary silicon particles, secondary silicon particles (silicon aggregates), a metal fluoride, and a metal silicate.

It is possible to obtain a porous composite having a plurality of pores formed on the surface, inside, or both of the composite particles through the etching.

In addition, as the selective etching removes a large amount of silicon dioxide, the silicon particles may comprise silicon (Si) in a very high fraction as compared with oxygen (O) on their surface. That is, the molar ratio of oxygen (O) atoms to silicon (Si) atoms (O/Si) present in the porous composite may be significantly reduced. In such a case, a secondary battery having a high capacity and excellent cycle characteristics as well as an improved first charge and discharge efficiency can be obtained.

In addition, pores or voids can be formed at the locations where silicon dioxide is removed. As a result, the specific surface area of the silicon-based composite may be increased as compared with the specific surface area of the silicon composite oxide before the etching step.

The silicon particles tend to form a natural film having a high oxygen fraction, that is, a silicon oxide film formed by natural oxidation of the surfaces of the silicon particles by oxygen or water in the air during filtration, drying, pulverization, and classification. The molar ratio (O/Si) of oxygen (O) atoms to silicon (Si) atoms present in the porous silicon-based composite may be 0.01 to 0.90, preferably, 0.02 to less than 0.90, more preferably, 0.02 to 0.70, even more preferably, 0.02 to 0.50. If the ratio is outside the above range, it acts as a resistance during the intercalation reaction of lithium, so that the electrochemical characteristics of a secondary battery may be deteriorated. As a result, the electrochemical characteristics, particularly, lifespan characteristics of the lithium secondary battery may be deteriorated.

In addition, if a silicon composite oxide having a large crystallite size of silicon is etched, the molar ratio (O/Si) of oxygen (O) atoms to silicon (Si) atoms upon the etching may decrease, which is preferable.

If the molar ratio (O/Si) of oxygen (O) atoms to silicon (Si) atoms present in the porous silicon-based composite is decreased within the above range, the initial capacity or cycle characteristics of a secondary battery may be enhanced.

According to an embodiment of the present invention, physical properties such as element content and specific surface area may vary before and after the etching step. That is, physical properties such as element content, pore volume, and specific surface area in the silicon composite oxide before the etching step and those in the silicon-based composite after the etching step may differ from each other.

For example, the content of metals, for example, magnesium (Mg) in the porous silicon-based composite may decrease or increase as compared with that in the silicon composite oxide.

In addition, a reduction rate of oxygen (O) in the porous silicon-based composite relative to the silicon composite oxide may be 5% to 98%, preferably, 15% to 95%, more preferably, 25% to 93%.

The porous silicon-based composite is a composite in which a plurality of silicon particles are uniformly distributed in a composite whose structure is in the form of a single mass, for example, a polyhedral, spherical, or similar shape. It may comprise secondary silicon particles (silicon aggregates) formed by the combination of two or more silicon particles (primary silicon particles) with each other. In such an event, the metal fluoride may be present on the surface of the silicon particles or between the silicon particles. In addition, the silicon particles may be present between the metal fluoride particles and may be surrounded by the metal fluoride.

In such an event, the porous silicon-based composite may comprise a porous silicon-based structure having a three-dimensional (3D) structure in which one or more silicon particles and one or more metal fluorides are combined with each other.

In addition, the porous silicon-based composite according to an embodiment of the present invention may comprise pores. Specifically, pores may be contained on the surface, inside, or both of the silicon-based composite. The surface of the silicon-based composite may refer to the outermost portion of the silicon-based composite. The inside of the silicon-based composite may refer to a portion other than the outermost portion, that is, an inner portion of the outermost portion. The pores may be more present in the outer portion than in the interior, and the pores may not be present in the interior. The depth from the outermost portion where pores are not present may be arbitrarily adjusted.

The process for preparing the porous silicon-based composite may further comprise filtering and drying the composite obtained by the etching (a third step). The filtration and drying step may be carried out by a commonly used method.

The preparation process according to an embodiment of the present invention has an advantage in that mass production is possible through a continuous process with minimized steps.

In addition, the porous silicon-based composite may have an average particle diameter (D₅₀) in the volume-based distribution measured by laser diffraction of 1 μm to 20 μm, specifically, 3 μm to 10 μm, more specifically, 3 μm to 8 μm. If D₅₀ is less than 1 μm, the bulk density is too small, and the charge and discharge capacity per unit volume may be deteriorated. On the other hand, if D₅₀ exceeds 20 μm, it is difficult to prepare an electrode layer, so that it may be peeled off from the current collector. The average particle diameter (D₅₀) is a value measured as a weight average value D₅₀, i.e., a particle diameter or median diameter when the cumulative weight is 50% in particle size distribution measurement according to a laser beam diffraction method.

In addition, according to an embodiment of the present invention, the process may further comprise pulverizing and classifying the porous silicon-based composite. The classification may be carried out to adjust the particle size distribution of the porous silicon-based composite, for which dry classification, wet classification, or classification using a sieve may be used. In the dry classification, the steps of dispersion, separation, collection (separation of solids and gases), and discharge are carried out sequentially or simultaneously using an air stream, in which pretreatment (adjustment of moisture, dispersibility, humidity, and the like) is carried out prior to the classification so as not to decrease the classification efficiency caused by interference between particles, particle shape, airflow disturbance, velocity distribution, and influence of static electricity, and the like, to thereby adjust the moisture or oxygen concentration in the air stream used. In addition, a desired particle size distribution may be obtained by carrying out pulverization and classification at one time. After the pulverization, it is effective to divide the coarse powder part and the granular part with a classifier or sieve.

A porous silicon-based composite powder having an average particle diameter of 1 μm to 20 μm may be obtained through the pulverization and classification treatment. The porous silicon-based composite powder may have a Dₘᵢₙ of 0.3 μm or less and a Dₘₐₓ of 8 μm to 30 μm. Within the above ranges, the specific surface area of the composite may be reduced, and the initial efficiency and cycle characteristics may be enhanced by about 10% to 20% as compared with before classification. The composite powder upon the pulverization and classification has an amorphous grain boundary and a crystal grain boundary, so that particle collapse by a charge and discharge cycle may be reduced by virtue of the stress relaxation effect of the amorphous grain boundary and the crystal grain boundary. When such silicon particles are used as a negative electrode active material of a secondary battery, the negative electrode active material of the secondary battery can withstand the stress of a change in volume expansion caused by charge and discharge and can exhibit characteristics of a secondary battery having a high capacity and a long lifespan. In addition, a lithium-containing compound such as Li₂O present in the SEI layer formed on the surface of a silicon-based negative electrode may be reduced.

A secondary battery using the porous silicon-based composite as a negative electrode may enhance its capacity, capacity retention rate, and initial efficiency.

[Process for Preparing a Porous Silicon-Based-Carbon Composite]

Meanwhile, the present invention, according to another embodiment, may provide a process for preparing a porous silicon-based-carbon composite, which comprises the porous silicon-based composite and carbon.

In the process for preparing a porous silicon-based-carbon composite, it may comprise forming a carbon layer on the surface of the porous silicon-based composite by using a chemical thermal decomposition deposition method after the preparation of the porous silicon-based composite.

The electrical contact between the particles of the porous silicon-based-carbon composite may be enhanced by the step of forming a carbon layer. In addition, as the charge and discharge are carried out, excellent electrical conductivity may be imparted even after the electrode is expanded, so that the performance of the secondary battery can be further enhanced. Specifically, the carbon layer may increase the conductivity of the negative electrode active material to enhance the output characteristics and cycle characteristics of a battery and may increase the stress relaxation effect when the volume of the active material is changed.

The carbon layer may comprise at least one selected from the group consisting of graphene, reduced graphene oxide, a carbon nanotube, a carbon nanofiber, and graphite.

The step of forming a carbon layer may be carried out by injecting at least one carbon source gas selected from a compound represented by the following Formulae 2 to 4 and carrying out a reaction of the porous silicon-based composite in a gaseous state at 400° C. to 1,200° C.

C_{N}H_{(2N+2-A)}[OH]_{A} [Formula 2]
in Formula 2, N is an integer of 1 to 20, and A is 0 or 1,

C_{N}H_{(2N-B)} [Formula 3]
in Formula 3, N is an integer of 2 to 6, and B is an integer of 0 to 2,

CₓH_{y}O_{z} [Formula 4]
in Formula 4, x is an integer of 1 to 20, y is an integer of 0 to 25, and z is an integer of 0 to 5.

In addition, in Formula 4, x may be the same as, or smaller than, y.

In addition, in Formula 4, y is an integer greater than 0 up to 25 or an integer of 1 to 25, and z is an integer greater than 0 up to 5 or an integer of 1 to 5.

The compound represented by Formula 2 may be at least one selected from the group consisting of methane, ethane, propane, butane, methanol, ethanol, propanol, propanediol, and butanediol. The compound represented by Formula 3 may be at least one selected from the group consisting of ethylene, acetylene, propylene, butylene, butadiene, and cyclopentene. The compound represented by Formula 4 may be at least one selected from the group consisting of benzene, toluene, xylene, ethylbenzene, naphthalene, anthracene, and dibutyl hydroxy toluene (BHT). Specifically, the compounds represented by Formulae 2 and 3 may comprise at least one selected from methane, ethylene, acetylene, propylene, methanol, ethanol, and propanol. The compound represented by Formula 4 may comprise toluene. If the carbon source compound comprises ethylene, acetylene, or toluene, carbon coating is possible by reaction at a low temperature of 500° C. to 800° C., so that the growth of silicon particles is suppressed, and the crystallite size of silicon particles is maintained at 30 nm or less, which is preferable. In addition, since the reaction is carried out at a low temperature, carbon coating is possible while the composite particles do not grow. In addition, a carbon coating may be uniformly formed on the surface of the pores in the interior of the porous silicon-based-carbon composite. This is preferable since the cycle lifespan is further enhanced.

The carbon source gas may further comprise at least one inert gas selected from hydrogen, nitrogen, helium, and argon.

The reaction may be carried out, for example, at 400° C. to 1,200° C., specifically, 500° C. to 1,100° C., more specifically, 600° C. to 1,000° C.

The reaction time (or thermal treatment time) may be appropriately adjusted depending on the thermal treatment temperature, the pressure during the thermal treatment, the composition of the gas mixture, and the desired amount of carbon coating. For example, the reaction time may be 10 minutes to 100 hours, specifically, 30 minutes to 90 hours, more specifically, 50 minutes to 40 hours, but it is not limited thereto. Without being bound by a particular theory, as the reaction time is longer, the thickness of the carbon layer formed increases, which may enhance the electrical properties of the porous silicon-based-carbon composite.

In the process for preparing a porous silicon-based-carbon composite according to an embodiment of the present invention, it is possible to form a thin and uniform carbon layer comprising at least one selected from graphene, reduced graphene oxide, a carbon nanotube, a carbon nanofiber, and graphite as a main component on the surface of the porous silicon-based composite even at a relatively low temperature through a gas-phase reaction of the carbon source gas. In addition, the detachment reaction in the carbon layer thus formed does not substantially take place.

In addition, since a carbon layer is uniformly formed over the entire surface of the porous silicon-based composite through the gas-phase reaction, a carbon film (carbon layer) having high crystallinity can be formed. Thus, when the porous silicon-based-carbon composite is used as a negative electrode active material, the electrical conductivity of the negative electrode active material can be enhanced without changing the structure.

According to an embodiment of the present invention, when a reactive gas containing the carbon source gas and an inert gas is supplied to the surface of the porous silicon-based composite, the reactive gas penetrates into the open pores of the porous silicon-based composite, and one or more graphene-containing materials selected from graphene, reduced graphene oxide, and graphene oxide, and a conductive carbon material such as a carbon nanotube and a carbon nanofiber are grown on the surface of the porous silicon-based composite. For example, as the reaction time elapses, the conductive carbon material deposited on the surface of silicon in the porous silicon-based composite is gradually grown to obtain a porous silicon-based-carbon composite.

The specific surface area of the porous silicon-based-carbon composite may decrease according to the amount of carbon coating.

The structure of the graphene-containing material may be a layer, a nanosheet type, or a structure in which several flakes are mixed.

If a carbon layer comprising a graphene-containing material is uniformly formed over the entire surface of the porous silicon-based composite, it is possible to suppress volume expansion as a graphene-containing material that has enhanced conductivity and is flexible for volume expansion is directly grown on the surface of the silicon particles and/or the fluoride. In addition, the coating of a carbon layer may reduce the chance that silicon directly meets the electrolyte, thereby reducing the formation of a solid electrolyte interphase (SEI) layer.

In addition, according to an embodiment of the present invention, the process may further comprise, after the formation of a carbon layer, pulverizing or crushing and classifying it such that the average particle diameter of the porous silicon-based-carbon composite is 1 μm to 15 μm. The classification may be carried out to adjust the particle size distribution of the porous silicon-based-carbon composite, for which dry classification, wet classification, or classification using a sieve may be used. In the dry classification, the steps of dispersion, separation, collection (separation of solids and gases), and discharge are carried out sequentially or simultaneously using an air stream, in which pretreatment (adjustment of moisture, dispersibility, humidity, and the like) may be carried out prior to the classification so as not to decrease the classification efficiency caused by interference between particles, particle shape, airflow disturbance, velocity distribution, and influence of static electricity, and the like, to thereby adjust the moisture or oxygen concentration in the air stream used. In addition, a desired particle size distribution may be obtained by carrying out crushing or pulverization and classification at one time. After the crushing or pulverization, it is effective to divide the coarse powder part and the granular part with a classifier or sieve.

The preparation process according to an embodiment of the present invention has an advantage in that mass production is possible through a continuous process with minimized steps.

A secondary battery using the porous silicon-based-carbon composite as a negative electrode may enhance its capacity, capacity retention rate, and initial efficiency.

Negative Electrode Active Material

The negative electrode active material according to an embodiment of the present invention may comprise the porous silicon-based composite. That is, the negative electrode active material may comprise a porous silicon-based composite comprising silicon particles and a fluoride.

In addition, the negative electrode active material may further comprise a carbon-based negative electrode material, specifically, a graphite-based negative electrode material.

The negative electrode active material may be used as a mixture of the porous silicon-based composite and the carbon-based negative electrode material, for example, a graphite-based negative electrode material. In such an event, the electrical resistance of the negative electrode active material can be reduced, while the expansion stress involved in charging can be relieved at the same time.

The carbon-based negative electrode material may comprise, for example, at least one selected from the group consisting of natural graphite, synthetic graphite, soft carbon, hard carbon, mesocarbon, carbon fibers, carbon nanotubes, pyrolytic carbon, coke, glass carbon fibers, sintered organic high molecular compounds, and carbon black.

The carbon-based negative electrode material may comprise porous carbon, carbon black, acetylene black, Ketjen black, channel black, fames black, lamp black, or thermal black.

The content of the carbon-based negative electrode material may be 30% by weight to 90% by weight, specifically, 30% by weight to 80% by weight, more specifically, 50% by weight to 80% by weight, based on the total weight of the negative electrode active material.

Secondary Battery

According to an embodiment of the present invention, the present invention may provide a negative electrode comprising the negative electrode active material and a secondary battery comprising the same.

The secondary battery may comprise a positive electrode, a negative electrode, a separator interposed between the positive electrode and the negative electrode, and a non-aqueous liquid electrolyte in which a lithium salt is dissolved. The negative electrode may comprise a negative electrode active material comprising a porous silicon-based composite.

The negative electrode may be composed of a negative electrode mixture only or may be composed of a negative electrode current collector and a negative electrode mixture layer (negative electrode active material layer) supported thereon. Similarly, the positive electrode may be composed of a positive electrode mixture only or may be composed of a positive electrode current collector and a positive electrode mixture layer (positive electrode active material layer) supported thereon. In addition, the negative electrode mixture and the positive electrode mixture may each further comprise a conductive agent and a binder.

Materials known in the art may be used as a material constituting the negative electrode current collector and a material constituting the positive electrode current collector. Materials known in the art may be used as a binder and a conductive material added to the negative electrode and the positive electrode.

If the negative electrode is composed of a current collector and an active material layer supported thereon, the negative electrode may be prepared by coating the negative electrode active material composition comprising the porous silicon-based composite on the surface of the current collector and drying it.

In addition, the secondary battery comprises a non-aqueous liquid electrolyte in which the non-aqueous liquid electrolyte may comprise a non-aqueous solvent and a lithium salt dissolved in the non-aqueous solvent. A solvent commonly used in the field may be used as a non-aqueous solvent. Specifically, an aprotic organic solvent may be used. Examples of the aprotic organic solvent include cyclic carbonates such as ethylene carbonate, propylene carbonate, and butylene carbonate, cyclic carboxylic acid esters such as furanone, chain carbonates such as diethyl carbonate, ethylmethyl carbonate, and dimethyl carbonate, chain ethers such as 1,2-methoxyethane, 1,2-ethoxyethane, and ethoxymethoxyethane, and cyclic ethers such as tetrahydrofuran and 2-methyltetrahydrofuran. They may be used alone or in combination of two or more.

The secondary battery may comprise a non-aqueous secondary battery.

The negative electrode active material and the secondary battery using the porous silicon-based composite may enhance the capacity, initial charge and discharge efficiency, and capacity retention rate thereof.

### EMBODIMENTS FOR CARRYING OUT THE INVENTION

Hereinafter, the present invention will be described in detail with reference to examples. The following examples are only illustrative of the present invention, and the scope of the present invention is not limited thereto.

### EXAMPLE

### Example 1

Preparation of a Porous Silicon-Based Composite

(1) Step 1: A silicon composite oxide powder having the element content and physical properties shown in Table 1 below was prepared using a silicon powder, a silicon dioxide powder, and metallic magnesium by the method described in Example 1 of Korean Laid-open Patent Publication 10-2018-0106485.

(2) Step 2: 50 g of the silicon composite oxide powder was dispersed in water, which was stirred at a speed of 300 rpm, and 500 ml of an aqueous solution of 30% by weight of HF was added as an etching solution over 20 minutes to etch the silicon composite oxide powder for 40 minutes to obtain 12.5 g of a composite.

(3) Step 3: The composite obtained by the above etching was filtered and dried at 150° C. for 2 hours. Then, in order to control the particle size of the composite, it was crushed using a mortar to have an average particle diameter of 5.8 μm, to thereby prepare a porous silicon-based composite (B1).

Fabrication of a Secondary Battery

A negative electrode comprising the porous silicon-based composite as a negative electrode active material and a battery (coin cell) were prepared.

Specifically, a mixture of the porous silicon-based composite and natural graphite (average particle size: 11 μm) at a weight ratio of 20:80 was used as a negative electrode active material.

The negative electrode active material, Super-P as a conductive material, and polyacrylic acid were mixed at a weight ratio of 94:1:5 with water to prepare a negative electrode active material composition having a solids content of 45%.

The negative electrode active material composition was applied to a copper foil having a thickness of 18 μm and dried to prepare an electrode having a thickness of 70 μm. The electrode was punched in a circular shape having a diameter of 14 mm to prepare a negative electrode plate for a coin cell.

Meanwhile, a metallic lithium foil having a thickness of 0.3 mm was used as a counter electrode.

A porous polyethylene sheet having a thickness of 25 μm was used as a separator. A liquid electrolyte in which LiPF₆ had been dissolved at a concentration of 1 M in a mixed solvent of ethylene carbonate (EC) and diethylene carbonate (DEC) at a volume ratio of 1:1 was used as an electrolyte. The above components were employed to fabricate a coin cell (battery) having a thickness of 3.2 mm and a diameter of 20 mm (CR2032 type).

### Examples 2 to 9

As shown in Tables 1 and 2 below, a porous silicon-based composite was prepared in the same manner as in Example 1, and a secondary battery using the same was manufactured, except that a silicon composite oxide powder having the element content and physical properties shown in Table 1 below was used and that the type of dispersion medium, etching conditions, and the like were changed.

### Example 10

The same porous silicon-based composite (composite B3) as in Example 3 was prepared.

10 g of the porous silicon-based composite (composite B3) was placed inside a tubular electric furnace, and argon (Ar) and methane gas flowed at a rate of 1 liter/minute, respectively. It was maintained at 900° C. for 1 hour and then cooled to room temperature, whereby the surface of the porous silicon-based composite was coated with carbon, to thereby prepare a porous silicon-based-carbon composite having a content of carbon of 29.5% by weight based on the total weight of the porous silicon-based-carbon composite.

As to the physical properties of the porous silicon-based-carbon composite, the size of Si (220) crystal grains of the porous silicon-based-carbon composite containing carbon was analyzed to be 7.9 nm, D₅₀ was 10.3 μm, and BET was 8.2 m²/g.

The porous silicon-based-carbon composite prepared above was used as a negative electrode active material to fabricate a secondary battery. The discharge capacity was 600 mAh/g, the initial efficiency was 87.3%, and the capacity retention rate after 50 cycles was 89.2%.

### Comparative Example 1

As shown in Tables 1 and 2 below, a silicon-based composite was prepared in the same manner as in Example 1, and a secondary battery using the same was manufactured, except that a silicon composite oxide powder having the element content and physical properties shown in Table 1 below was used and that etching was not carried out.

### Comparative Example 2

A negative electrode active material and a secondary battery using the same were prepared in the same manner as in Example 1, except that 50 g of a silicon composite oxide (A2) powder was etched with aqua regia, instead of the HF etching solution, for 12 hours at 70° C. to prepare 12 g of a composite.

### Comparative Example 3

A negative electrode active material and a secondary battery using the same were prepared in the same manner as in Example 1, except that 50 g of a silicon composite oxide (A2) powder was etched with NaOH, instead of the HF etching solution, for 12 hours at room temperature to prepare 13 g of a composite.

### Test Example

### <Test Example 1> Electron Microscope Analysis

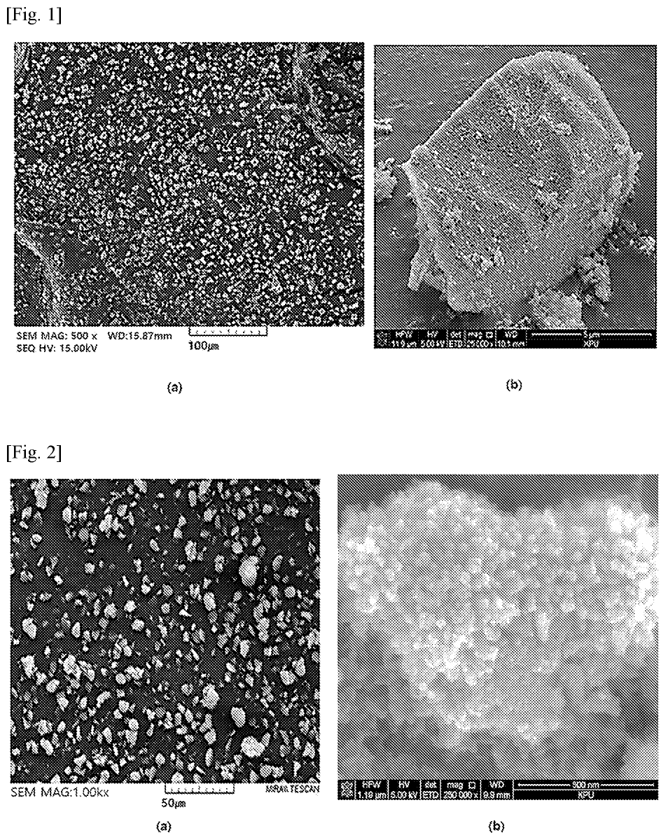

FIG. 1 is a result of observing the surface of the porous silicon-based composite (composite B1) prepared in Example 1 using a scanning electron microscope (FE-SEM) photograph (5-4700, Hitachi). FIGS. 1(a) and 1(b) are shown at different magnifications of 500 times and 25,000 times, respectively.

Referring to FIGS. 1(a) and 1(b), pores were present on the surface of the porous silicon-based composite (composite B1) prepared in Example 1.

FIG. 2 is a result of observing the surface of the porous silicon-based composite (composite B4) prepared in Example 4 using a scanning electron microscope (FE-SEM) photograph (5-4700, Hitachi). FIGS. 2(a) and 2(b) are shown at different magnifications of 1,000 times and 250,000 times, respectively.

Referring to FIG. 2, pores were present on the surface of the porous silicon-based composite (composite B4) prepared in Example 4.

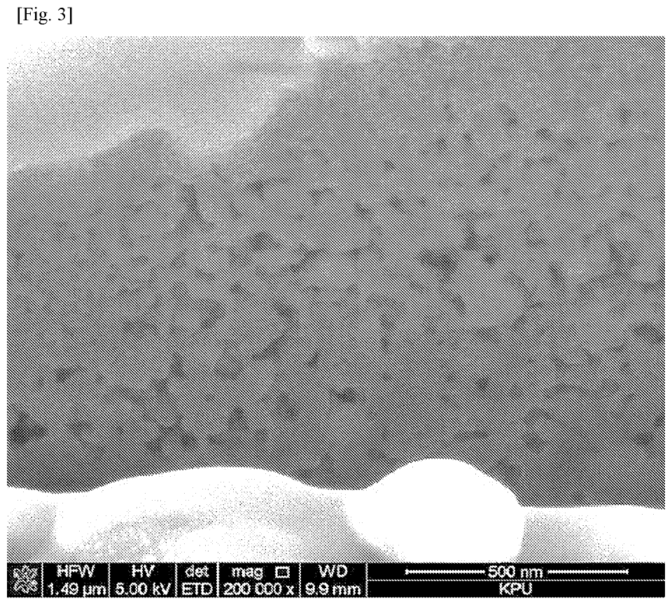

In addition, FIG. 3 is a result of observing the inside of the porous silicon-based composite (composite B4) prepared in Example 4 using an ion beam scanning electron microscope photograph (FIB-SEM, 5-4700; Hitachi, QUANTA 3D FEG; FEI) at a magnification of 200,000 times.

Referring to FIG. 3, pores were present inside the porous silicon-based composite (composite B4) prepared in Example 4. It can be inferred from FIG. 3 that pores were formed by the etching solution that penetrated into the porous silicon-based composite.

### <Test Example 2> X-Ray Diffraction Analysis

The crystal structures of the silicon composite oxide (composite A) and the porous silicon-based composite (composite B) prepared in the Examples were analyzed with an X-ray diffraction analyzer (Malvern Panalytical, X'Pert3).

Specifically, the applied voltage was 40 kV and the applied current was 40 mA. The range of 2θ was 10° to 90°, and it was measured by scanning at an interval of 0.05°.

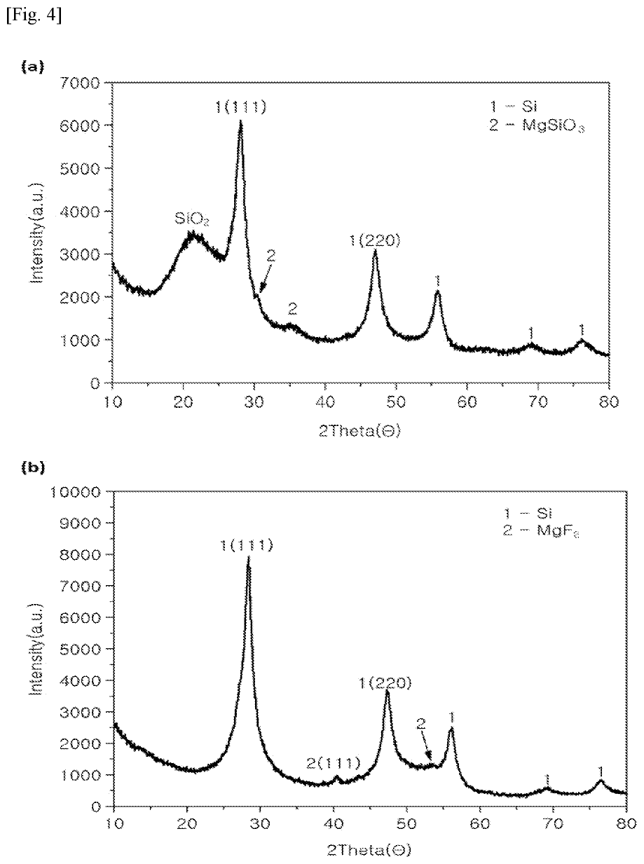

FIG. 4 shows the measurement results of an X-ray diffraction analysis of the silicon composite oxide (composite A1) and the porous silicon-based composite (composite B1) of Example 1.

Referring to FIG. 4(a), as can be seen from the X-ray diffraction pattern, the silicon composite oxide (composite A1) of Example 1 had a peak corresponding to SiO₂ around a diffraction angle (2θ) of 21.4°; peaks corresponding to Si crystals around diffraction angles (2θ) of 28.0°, 47.0°, 55.8°, 68.9°, and 76.1°; and peaks corresponding to MgSiO₃ crystals around diffraction angles (2θ) of 30.3° and 35.1°, which confirms that the silicon composite oxide comprised amorphous SiO₂, crystalline Si, and MgSiO₃.

Referring to FIG. 4(b), as can be seen from the X-ray diffraction pattern, the porous silicon-based composite (composite B1) of Example 1 had peaks corresponding to MgF₂ crystals around diffraction angles (2θ) of 40.4° and 53.5°; and peaks corresponding to Si crystals around diffraction angles (2θ) of 28.3°, 47.2°, 56.0°, 69.0°, and 76.4°. In addition, as the peak corresponding to MgSiO₃ disappeared and the peak corresponding to MgF₂ appeared, it can be seen that MgSiO₃ was converted to MgF₂ upon etching.

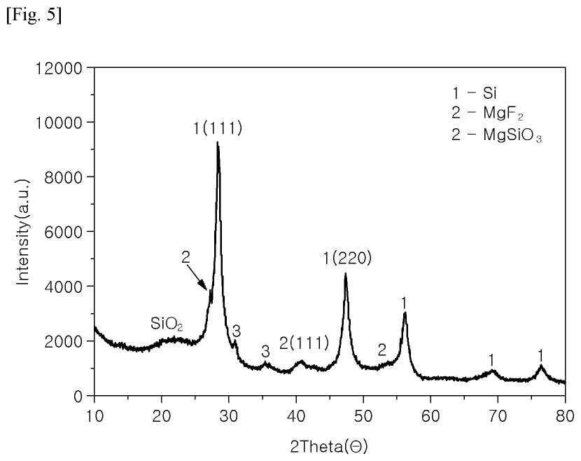

FIG. 5 shows the measurement results of an X-ray diffraction analysis of the porous silicon-based composite (composite B5) of Example 5.

Referring to FIG. 5, as can be seen from the X-ray diffraction pattern, the porous silicon-based composite (composite B5) of Example 5 had a peak corresponding to SiO₂ around a diffraction angle (2θ) of 21.7°; peaks corresponding to Si crystals around diffraction angles (2θ) of 28.4°, 47.3°, 56.10, 69.2°, and 76.4°; peaks corresponding to MgSiO₃ crystals around diffraction angles (2θ) of 30.8° and 35.4°, and peaks corresponding to MgF₂ crystals around diffraction angles (2θ) 27.2°, 40.5°, and 53.4°, which confirms that it comprised SiO₂, crystalline Si, MgSiO₃, and MgF₂ upon the etching.

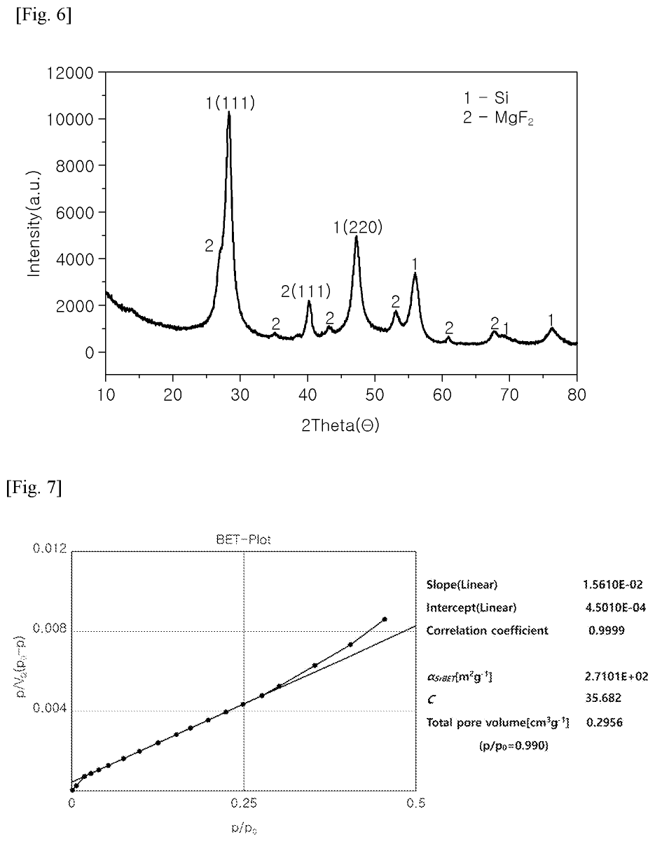

FIG. 6 shows the measurement results of an X-ray diffraction analysis of the porous silicon-based composite (composite B8) of Example 8.

Referring to FIG. 6, as can be seen from the X-ray diffraction pattern, the porous silicon-based composite (composite B8) of Example 8 had peaks corresponding to MgF₂ crystals around diffraction angles (2θ) of 27.2°, 35.0°, 40.2°, 43.10, 53.10, 60.8°, and 67.7°; and peaks corresponding to Si crystals around diffraction angles (2θ) of 27.2°, 40.5°, and 53.4°. In addition, as the peak corresponding to MgSiO₃ disappeared and the peak corresponding to MgF₂ appeared, it can be seen that MgSiO₃ was converted to MgF₂ upon etching.

Meanwhile, the crystallite size of Si in the obtained porous silicon-based composite was determined by the Scherrer equation of the following Equation 2 based on a full width at half maximum (FWHM) of the peak corresponding to Si (220) in the X-ray diffraction analysis.

Crystal size (nm)=Kλ/B cos θ [Equation 2]

In Equation 2, K is 0.9, λ is 0.154 nm, B is a full width at half maximum (FWHM), and θ is a peak position (angle).

### <Test Example 3> Analysis of the Content of the Component Elements and Specific Gravity of the Composites

The content of each component element of magnesium (Mg), oxygen (O), and silicon (Si) in the composites prepared in the Examples and Comparative Examples were analyzed.

The contents of magnesium (Mg) and silicon (Si) were analyzed by inductively coupled plasma (ICP) emission spectroscopy using Optima-5300 of PerkinElmer. The content of oxygen (O) was measured by O-836 of LECO, and an average of three measurements was obtained. The content of carbon (C) was analyzed by a CS-744 elemental analyzer of LECO. The content of fluorine (F) was a value calculated based on the contents of silicon (Si), oxygen (O), and magnesium (Mg).

In addition, the specific gravity (particle density) was measured 5 times by filling ⅔ of a 10 ml container with the prepared composite using Accupyc II 1340 of Micromeritics.

### <Test Example 4> Measurement of an Average Particle Diameter of Composite Particles

The average particle diameter (D₅₀) of the composite particles prepared in the Examples and Comparative Examples was measured as a weight average value D₅₀, i.e., a particle size or median diameter when the cumulative volume is 50% in particle size distribution measurement according to a laser beam diffraction method using S3500 of Microtrac.

### <Test Example 5> Measurement of the Capacity, Initial Efficiency, and Capacity Retention Rate of Secondary Batteries

The coin cells (secondary batteries) prepared in the Examples and Comparative Examples were each charged at a constant current of 0.1 C until the voltage reached 0.005 V and discharged at a constant current of 0.1 C until the voltage reached 2.0 V to measure the charge capacity (mAh/g), discharge capacity (mAh/g), and initial efficiency (%). The results are shown in Table 4 below.

Initial efficiency (%)=discharge capacity/charge capacity×100 [Equation 3]

In addition, the coin cells prepared in the Examples and Comparative Examples were each charged and discharged once in the same manner as above and, from the second cycle, charged at a constant current of 0.5 C until the voltage reached 0.005 V and discharged at a constant current of 0.5 C until the voltage reached 2.0 V to measure the cycle characteristics (capacity retention rate upon 50 cycles, %). The results are shown in Table 3 below.

Capacity retention rate upon 50 cycles (%)=51^{st} discharge capacity/2^{nd} discharge capacity×100 [Equation 4]

The content of each element and physical properties of the composites prepared in the Examples and Comparative Examples are summarized in Tables 1 and 2 below. The characteristics of the secondary batteries using the same are summarized in Table 3 below.

### <Test Example 6> Analysis of Specific Surface Area

The composites prepared in the Examples and Comparative Examples were placed in a tube and treated with a pretreatment device (BELPREP-vac2) of MicrotracBEL at 10⁻² kPa and 100° C. for 5 hours.

Upon the pretreatment, the tube was mounted on the analysis port of an analysis device (BELSORP-max) with liquid nitrogen filled in the Dewar to carry out an analysis.

Upon completion, the range of data was adjusted such that the correlation coefficient approached 0.9999, and the specific surface area (BET) and pore volume were obtained.

FIG. 7 shows the measurement results of a specific surface area (Brunauer-Emmett-Teller Method; BET) analysis of the porous silicon-based composite (composite B3) of Example 3.

Referring to FIG. 7, as can be seen from the BET measurement results, the porous silicon-based composite of Example 3 (composite B3) had a specific surface area (BET) of about 271 m²/g and a pore volume of about 0.296 cc/g.

TABLE 1

| | | | | | | | | | | | Comparative | | |
|---|---|---|---|---|---|---|---|---|---|---|---|---|---|
| | | Example | | | | | | | | | Example | | |
| | | 1 | 2 | 3 | 4 | 5 | 6 | 7 | 8 | 9 | 1 | 2 | 3 |
| Silicon | Name | A1 | | | A2 | | | A3 | A4 | A5 | A2 | | |
| composite | Mg content | 2 | | | 5.3 | | | 0.8 | 7.9 | 12 | 5.3 | | |
| oxide | (% by weight) | | | | | | | | | | | | |
| (Composite | O content | 34.2 | | | 33.1 | | | 34.8 | 31 | 31.3 | 33.1 | | |
| A) | (% by weight) | | | | | | | | | | | | |
| | D₅₀ (μm) | 5.04 | | | 5.9 | | | 5.0 | 5.46 | 5.99 | 5.9 | | |
| | Particle density | 2.38 | | | 2.46 | | | 2.36 | 2.52 | 2.64 | 2.46 | | |
| | (g/cm³) | | | | | | | | | | | | |

| | | | | | | |
|---|---|---|---|---|---|---|
| BET (m²/g) | 4.84 | 10.8 | 6.6 | 12.2 | 6.7 | 10.8 |
| Pore volume (cc/g) | 0.0074 | 0.0099 | 0.0069 | 0.0154 | 0.0284 | 0.0099 |

TABLE 2

| | | | | | | | | | | | Comparative | | |
|---|---|---|---|---|---|---|---|---|---|---|---|---|---|
| | | Example | | | | | | | | | Example | | |
| | | 1 | 2 | 3 | 4 | 5 | 6 | 7 | 8 | 9 | 1 | 2 | 3 |
| Porous | Name | B1 | B2 | B3 | B4 | B5 | B6 | B7 | B8 | B9 | | B10 | B11 |
| silicon- | Oxygen | 88 | 59 | 42 | 85 | 26 | 42 | 93 | 89 | 54 | | — | — |
| based | reduction rate | | | | | | | | | | | | |
| composite | (%) | | | | | | | | | | | | |
| (Composite | Mg content | 1.4 | 2.3 | 1.9 | 5.7 | 7.1 | 5.3 | 3.5 | 9.5 | 12.5 | | 7 | 4.5 |
| B) | (% by weight) | | | | | | | | | | | | |
| | O content | 4.0 | 13.9 | 19.8 | 4.9 | 24.4 | 19.2 | 2.4 | 3.4 | 14.3 | | 35 | 36.8 |
| | (% by weight) | | | | | | | | | | | | |
| | F content as a | 1.9 | 2.2 | 1.2 | 7.6 | 4.4 | 3.5 | 5.1 | 13.2 | 10.6 | | 0 | 0 |
| | calculated | | | | | | | | | | | | |
| | value | | | | | | | | | | | | |
| | (% by weight) | | | | | | | | | | | | |
| | Si content | 92.7 | 81.6 | 77.1 | 81.7 | 64.1 | 72.1 | 89 | 73.9 | 62.6 | | 58 | 58.7 |
| | (% by weight) | | | | | | | | | | | | |
| | O/Si | 0.08 | 0.3 | 0.45 | 0.11 | 0.67 | 0.47 | 0.05 | 0.08 | 0.40 | | 1.06 | 1.1 |
| | molar ratio | | | | | | | | | | | | |
| | Mg/Si | 0.02 | 0.03 | 0.03 | 0.08 | 0.13 | 0.09 | 0.05 | 0.15 | 0.23 | | 0.14 | 0.09 |
| | molar ratio | | | | | | | | | | | | |
| | Si (220) (nm) | 6.7 | 5.8 | 6.3 | 8.57 | 9.4 | 7.67 | 7.3 | 10 | 10.2 | | 7.6 | 7.8 |
| | Particle | 1.87 | 2.01 | 2.04 | 2.02 | 2.35 | 2.22 | 1.76 | 2.23 | 2.57 | | 2.47 | 2.49 |
| | density | | | | | | | | | | | | |
| | (g/cm³) | | | | | | | | | | | | |
| | BET (m²/g) | 621 | 404 | 271 | 492 | 55 | 263 | 819 | 231 | 135 | | 18 | 14 |
| | Pore volume | 0.703 | 0.431 | 0.296 | 0.602 | 0.168 | 0.475 | 0.672 | 0.535 | 0.271 | | 0.048 | 0.027 |
| | (cc/g) | | | | | | | | | | | | |
| | Porosity (%) | 56.8 | 46.4 | 37.6 | 54.9 | 28.3 | 51.3 | 54.2 | 54.4 | 41.1 | | 10.6 | 6.3 |
| | Micropore | 36.7 | 33.0 | 36.9 | 32.8 | 13.4 | 26.9 | 45.8 | 17.9 | 7.2 | | 0 | 0 |
| | (% by volume) | | | | | | | | | | | | |
| | Mesopore | 52.8 | 60.7 | 55.2 | 56.9 | 68.2 | 56.8 | 49.4 | 63.1 | 73.5 | | 4.5 | 2.5 |
| | (% by volume) | | | | | | | | | | | | |
| | Macropore | 10.5 | 6.2 | 7.9 | 10.2 | 18.4 | 16.3 | 4.8 | 19.0 | 19.3 | | 96.5 | 97.5 |
| | (% by volume) | | | | | | | | | | | | |
| | D₅₀ (μm) | 5.8 | 5.6 | 5.7 | 6.0 | 5.9 | 5.4 | 5.1 | 5.9 | 6.1 | | 4.5 | 4.6 |
| | Pore volume | 95.0 | 58.2 | 39.9 | 61.0 | 17.0 | 48.1 | 97.4 | 34.7 | 9.5 | | 4.8 | 2.7 |
| | ratio | | | | | | | | | | | | |
| | after/before | | | | | | | | | | | | |
| | etching | | | | | | | | | | | | |

TABLE 3

| | | | | | | | | | | | Comparative | | |
|---|---|---|---|---|---|---|---|---|---|---|---|---|---|
| | | Example | | | | | | | | | Example | | |
| | | 1 | 2 | 3 | 4 | 5 | 6 | 7 | 8 | 9 | 1 | 2 | 3 |
| Characteristics | Discharge capacity | 739 | 642 | 625 | 656 | 556 | 582 | 787 | 651 | 487 | 581 | 572 | 546 |
| of the | (mAh/g) | | | | | | | | | | | | |
| secondary | Initial efficiency (%) | 86.5 | 85.8 | 84.8 | 86.5 | 85.7 | 86.0 | 86.7 | 86.4 | 86.0 | 84.3 | 85.0 | 83.2 |
| battery | Capacity retention | 85.6 | 84.3 | 84.5 | 82.1 | 80.8 | 83.4 | 85.9 | 82.8 | 80.1 | 76.3 | 73.2 | 72.7 |
| | rate upon 50 cycles | | | | | | | | | | | | |
| | (%) | | | | | | | | | | | | |

As can be seen from Tables 2 and 3, the porous silicon-based composites of Examples 1 to 9 according to an embodiment of the present invention had excellent selective etching efficiency, and the negative electrode active material using them had excellent performance of secondary batteries, as compared with the composites of the Comparative Examples.

First, when the composites of Example 1 and Comparative Examples 2 and 3 are compared, the yield of the composite of Example 1 was 12.5 g upon etching, and those of the composites of Comparative Examples 2 and 3 were 12 g and 13 g upon etching, respectively. Thus, the yields of the composites upon etching were similar. Referring to Table 2, however, the O/Si molar ratio of the composite of Example 1 was 0.08, whereas the O/Si molar ratios of the composites of Comparative Examples 2 and 3 were 1.06 and 1.1, respectively, indicating that the composite of Example 1 and the composite of Comparative Examples 2 and 3 showed a great difference in the O/Si molar ratio.

The above results show that the composite of Example 1 had excellent selective etching efficiency and contained silicon (Si) atoms at a very high fraction relative to oxygen (O) atoms, whereas the composites of Comparative Examples 2 and 3 contained silicon (Si) atoms at a very low fraction relative to oxygen (O) atoms since selective etching was not carried out even when the etching step was performed.

In addition, as to the pores of the composites, the porous silicon-based composites of Examples 1 to 9 contained all of micropores, mesopores, and macropores, in which the total volume of the mesopores was 49.4% by volume to 73.5% by volume based on the total volume of the entire pores, whereas the composites of Comparative Examples 2 and 3 did not contain micropores while containing 96% by volume or more of macropores.

Meanwhile, as can be seen from Table 3, the secondary batteries prepared using the porous silicon-based composites of Examples 1 to 9 of the present invention were significantly enhanced in, especially, capacity retention rate upon 50 cycles, while excellent initial efficiency was maintained, as compared with the secondary batteries of Comparative Examples 1 to 3.

Specifically, the secondary batteries of Examples 1 to 9 had an excellent initial efficiency of 84.8% to 86.7% and a capacity retention rate of 80.1% to 85.9%.

In particular, in Examples 1 to 4, 7, and 8, excellent initial efficiency and capacity retention rates as well as discharge capacities up to 600 mAh/g or more were achieved.

In contrast, the secondary batteries of Comparative Examples 1 to 3 had a significantly reduced capacity retention rate of 72.7% to 76.3% as compared to the secondary batteries of Examples 1 to 9. The discharge capacity of 546 to 581 mAh/g was also significantly reduced as compared with the secondary batteries of Examples 1 to 4, 7, and 8.

Meanwhile, in the secondary battery prepared using the porous silicon-based-carbon composite of Example 10 in which carbon was coated on the surface of the porous silicon-based composite according to an embodiment of the present invention, the discharge capacity was 600 mAh/g, the initial efficiency was 87.3%, and the capacity retention rate upon 50 cycles was 89.2%, confirming that the performance of the secondary battery was further enhanced.

1. A porous silicon-based composite, which comprises silicon particles and a fluoride.

2. The porous silicon-based composite of claim 1, wherein the fluoride comprises a metal fluoride.

3. The porous silicon-based composite of claim 2, wherein the metal fluoride comprises fluorine-containing magnesium compound, and the fluorine-containing magnesium compound comprises magnesium fluoride (MgF₂), magnesium fluoride silicate (MgSiF₆), or a mixture thereof.

4. The porous silicon-based composite of claim 1, wherein the porous silicon-based composite comprises pores on its surface, inside, or both, and
the porosity of the porous silicon-based composite is 10% by volume to 80% by volume based on the volume of the porous silicon-based composite.

5. The porous silicon-based composite of claim 4, wherein the porous silicon-based composite has a pore volume of 0.1 cc/g to 0.9 cc/g.

6. The porous silicon-based composite of claim 4, wherein when the surface of the porous silicon-based composite is measured by a gas adsorption method (BET plot method), it comprises micropores of 2 nm or less; mesopores of greater than 2 nm to 50 nm; and macropores of greater than 50 nm to 250 nm, and
the total volume of the mesopores is 30% by volume to 80% by volume based on the total volume of the entire pores.

7. The porous silicon-based composite of claim 3, wherein the crystallite size of the magnesium fluoride (MgF₂) is 3 nm to 35 nm.

8. The porous silicon-based composite of claim 1, wherein the porous silicon-based composite further comprises a metal silicate.

9. The porous silicon-based composite of claim 8, wherein the metal silicate comprises magnesium silicate, and the magnesium silicate comprises MgSiO₃ crystals, Mg₂SiO₄ crystals, or a mixture thereof.

10. The porous silicon-based composite of claim 8, wherein the content of metals in the porous silicon-based composite is 0.2% by weight to 20% by weight based on the total weight of the porous silicon-based composite.

11. The porous silicon-based composite of claim 3, wherein when the porous silicon-based composite is subjected to an X-ray diffraction analysis, it has an IB/IA, as a ratio of the diffraction peak intensity (IB) corresponding to an MgF₂ (111) crystal plane of the magnesium fluoride to the diffraction peak intensity (IA) of an Si (220) crystal plane, of greater than 0 to 1.0.

12. The porous silicon-based composite of claim 1, wherein the porous silicon-based composite further comprises a silicon oxide compound.

13. The porous silicon-based composite of claim 12, wherein the silicon oxide compound is SiOₓ (0.5≤x≤2).

14. The porous silicon-based composite of claim 9, wherein the molar ratio (Mg/Si) of magnesium atoms to silicon atoms present in the porous silicon-based composite is 0.01 to 0.30.

15. The porous silicon-based composite of claim 1, wherein the content of silicon (Si) in the porous silicon-based composite is 30% by weight to 99% by weight based on the total weight of the porous silicon-based composite.

16. The porous silicon-based composite of claim 1, wherein the silicon particles have a crystallite size of 1 nm to 30 nm in an X-ray diffraction analysis.

17. The porous silicon-based composite of claim 12, wherein the molar ratio (O/Si) of oxygen atoms to silicon atoms present in the porous silicon-based composite is 0.01 to 0.90.

18. The porous silicon-based composite of claim 1, wherein the porous silicon-based composite has an average particle diameter (D₅₀) of 1 μm to 20 μm.

19. The porous silicon-based composite of claim 1, wherein the porous silicon-based composite has a specific gravity of 1.6 g/cm³ to 2.6 g/cm³ and a specific surface area (Brunauer-Emmett-Teller method; BET) of 50 m²/g to 1,500 m²/g.

20. A process for preparing the porous silicon-based composite of claim 1, which comprises:
a first step of obtaining a silicon composite oxide powder using a silicon-based raw material and a metal-based raw material; and
a second step of etching the silicon composite oxide powder using an etching solution comprising a fluorine (F) atom-containing compound.

21. A porous silicon-based-carbon composite, which comprises the porous silicon-based composite of claim 1 and carbon.

22. A negative electrode active material, which comprises the porous silicon-based composite of claim 1 and a carbon-based negative electrode material.

23. A lithium secondary battery, which comprises the negative electrode active material of claim 22.
